(19) United States
(12) Patent Application Publication
(10) Pub. No.: US 2014/0266061 A1
(43) Pub. Date: Sep. 18, 2014

(54) Heterogeneous Energy Storage System and Associated Methods

(71) Applicant: Manitoba Hydro International Ltd., Winnipeg (CA)

(72) Inventor: Randy W. Wachal, Winnipeg (CA)

(21) Appl. No.: 14/203,850

(22) Filed: Mar. 11, 2014

Related U.S. Application Data
(60) Provisional application No. 61/778,938, filed on Mar. 13, 2013.

(51) Int. Cl. H02J 7/00; H01M 10/44

(52) U.S. Cl. CPC H02J 7/0068; H01M 10/441
USPC 320/134

(57) ABSTRACT

A power supply system between a power supply and an electrical load uses a plurality of battery modules which may be different in configuration from one another. The system assesses one or more state variables for each battery module to indicate a health status of the battery module. The variable indicative of the health status typically includes: i) a residual ability of the battery module to accept electric charge, ii) a residual capacity of the battery module to hold electric charge, iii) an internal resistance of the battery module, iv) a conductance of the battery module, v) a capacitance of the battery module, vi) a rate of charge of the battery module, vii) a rate of discharge of the battery module under load, or viii) a rate of self-discharge of the battery module. The system then generates unique charging and discharging criteria for each battery module which is specifically derived from the health status of the battery module.

This application claims the benefit under 35 U.S.C. 119(e) of U.S. provisional application Ser. No. 61/778,938, filed Mar. 13, 2013.

### FIELD OF INVENTION

The present invention relates in general to novel method and system for management and operation of electricity storage systems involving heterogeneous electricity storage units.

### BACKGROUND OF THE INVENTION

With increasing adoption of electronic devices and vehicles, significant investments have been made in developing battery technologies to drive down costs, achieve greater energy densities, and smaller battery sizes. For example, lithium-ion batteries today represent a ten-fold drop in installed costs when compared to conventional redox flow systems.

Further, the continuing improvements and increasing prevalence of electric vehicles (whether hybrid electric or plug-in electric) in society, repurposing and using used batteries from these vehicles after their factory operational lifespan may also be viable for electric utility applications. A repurposed battery from an electric vehicle can be described as a battery that has undergone a predetermined number of thousands of partial charging and discharging cycles, but still possessing a majority (e.g. 80%) of the battery capacity remaining at the end of the typical 10 year vehicle battery life.

As the nomenclature implies, energy storage technologies can temporarily store energy (e.g. in the form of electricity) for later release and consumption. The more obvious role that an energy storage system, therefore, can assume in an electric utility setting can include their ability to help manage fluctuations and intermittency of generation and load, such as peak load management and integration of renewable energy sources such as wind or solar into an electrical grid. For instance, through the ability to act as a power reserve, energy storage can be utilized to co-supply electricity (with generation) during peak load periods, which could defer and/or delay the need for of building additional power generation capacity should peak load is beginning to exceed generation capacity. The types of generation for an urban load can be the more conventional nuclear, thermal, or hydro, power generation, but more remote communities possessing limited resources oftentimes have to rely more so on local power generation by smaller stand-alone combustion engine generators (such as a diesel engine generators).

A reasonable representation of the current state-of-the-art respecting the use of energy storage technology in/for electrical utility applications can be found in U.S. Letters Patent Application No. 2012/0068540. In this application, Luo et al. teaches the use of a backup energy storage system to support the power grid, based on the frequency and the phase of the power grid, to meet the electric power consumption during the peak period, in case electricity consumption exceeds the capacity/output of the power grid, thereby stretching capacities of power generation to meet increasing peak periods of power consumption. In other words, when the controller of the energy storage system detects a power deficiency from the power grid that may not meet the consumers' needs, the system would go into a discharging mode, whilst when the controller detects excess power from the power grid, the system would go into a charging mode to re-charge the energy storage tanks.

Similarly, U.S. Letters Patent Application No. 2012/0146585 also describes a method of using an energy storage system for responding to a change in electric power demand by adjusting the discharge of the energy storage system to provide a regulation up service (when additional electric power is needed, such as during times of peak electric power demand) or to provide a regulation down service (when the energy storage system absorbs or stores electric power from the utility's electric power grid, such as when electric power demand drops, or when purchase price for electric power from the electric power grid is low.

As evidently presented in these relatively recent patent applications, the role and function of the energy storage system, as envisaged by the inventors, in the electrical utility setting are just relatively simple reservoirs of stored electricity that can be used to meet load demand over and above what can be provided by generation.

In terms of the actual setup and implementation, although the inventors in these applications describe the involvement of a plurality of energy storage tanks or subsystems (batteries) connected in parallel, and the use of controllers and/or switches to control the charging and discharging of the energy storage tanks or subsystems according to load/demand, neither application provides any detail as to how best the energy storage tanks or subsystems should be charged or discharged when they are electrically arranged and connected in parallel.

It is well known that when a number of batteries are connected and arranged in a parallel configuration, having a “weak” cell in the mix can dramatically reduces the total load capability of the battery bank. Furthermore, a faulty cell would drain energy from the other cells, thereby causing electrical short. Although a minor electrical short can just result in a faster self-discharge, hence reduced runtime and utility of the battery bank, a more major electrical short can become a fire hazard causing explosion and serious damage.

Further, considering the fast pace of advancement in energy storage (e.g. battery) technology, and considering the environmental and cost benefits of repurposing all different automotive batteries per above, it would be desirable if an energy storage system can operate with batteries of different voltage ratings, designs, chemistry, age, residual runtime and capacity, as a single energy storage system.

Neither of the foregoing prior art provides any guidance whatsoever as how to properly manage the charging and discharging of batteries connected in parallel or to accommodate a heterogeneous setup comprising batteries (especially repurposed batteries) with, for example, different voltage ratings, designs, chemistry, age, residual runtime and capacity.

From a review of other prior art that is more specific to charging of multiple batteries in parallel.

At a relatively simplistic level, U.S. Letters Patent No. 2009/0206795 teaches a selector circuit that uses basic switches to prevent inter-battery current flow from a higher potential battery to a lower potential battery coupled in parallel (so to prevent the potential adversities as aforementioned).

It was also realized that when multiple batteries are connected in series or parallel, it is possible that the batteries can have different amounts of power left in them at the time of connection. Early teachings would stipulate that such batteries would have to be first discharged before charging can begin, but U.S. Pat. No. 6,097,174 teaches a charging circuit that can circumvent this step and can individually or simultaneously initiate charging of multiple batteries without first discharge.

In terms of charging strategies, U.S. Letters Patent Application No. 2012/0274145 teaches a circuit that can render an energy storage device “parallelable” and that the energy storage device is charged (or discharged) following a straight pre-determined or pre-set monotonic or linear function depending on the energy storage device's state of charge at a given time.

To take into consideration that the charge current available to an energy storage system may be limited to the capacity of a common power source, U.S. Letters Patent Application No. 2009/0230920 teaches a battery charger for charging a plurality of batteries, wherein the charge current applied to each battery is continuously monitored by a respective charge manager, and that a cross-over controller controls the amount of charge current that is applied by each charge manager so that the total charge current applied by all charge managers does not exceed the maximum available current provided by the common power source.

By comparison, other approaches for charging and/or discharging are driven by simple-logic based on certain basic parameters relating to the batteries. Accordingly, adjustments to charging current are triggered if certain basic condition, rule, or criterion, is detected/met.

For example, U.S. Letters Patent Application No. 2009/0045775 teaches a charging control circuit for controlling charging of a plurality of batteries coupled in parallel, wherein the charging control circuit monitors the charging current and battery charging voltage provided to each of the batteries, and reduces charging provided to said plurality of batteries if: (i) a first battery charging current exceeds a first maximum charging current level or a second battery charging current exceeds a second maximum charging current level; or (ii) a first battery charging voltage exceeds a first maximum charging voltage level or a second battery charging voltage exceeds a second maximum charging voltage level.

Similarly, U.S. Letters Patent Application No. 2012/0153899 teaches a multiple battery charger that can split the charge current available to the various batteries according to a relatively simple algorithm based on the relative charge level of the batteries at a given time: The battery with the lowest charge level receives the highest charge current until equilibrium is reached (i.e. when the charge levels of all batteries are the same).

It is appreciable that a number of these prior art technologies arose out of, and pertain to, the low voltage portable electronic devices industry, and the foregoing prior art are designed based on making electronic adjustments of charge current from a fixed common power source that supplies all of the batteries. U.S. Letters Patent Application No. 2012/0268076, to the contrary, teaches that selecting power rather than controlling power may be a cheaper way of controlling the amount of power delivered to the batteries. In this case, a plurality of electric power sources to a battery is available to supply power a plurality of batteries, and means to select a combination of the plurality of electric power sources so that different combinations of charging current can be selected on a case-by-case basis to charge the batteries.

In light of the foregoing, none of the prior art to date teach a single energy storage system that can accommodate different batteries with different voltage and charge ratings, different designs, different chemistries, different age, and especially, different health statuses with different residual runtimes and capacities. Seeing the increasing prevalence of electric vehicles and that new battery technologies utilizing novel chemistries are constantly being developed, it would be desired if one is able to productively dispose of the significant number of “spent” batteries from these vehicles. At this stage, however, there remains the need for a method and system that can enable effective and safe operation of each battery, within the context of the whole system comprising of a plurality of heterogeneous batteries, with each of them having its own unique characteristics and properties independently and differently from the others all inter-connected within the energy storage system.

In other words, each battery within the system may be a repurposed battery that can have uniquely different rating, design, chemistry, age, and health status, compared to each other(s).

At this point, it is important to note the distinction between the “health status” (“state of health”) of a battery as opposed to the “state of charge” of a battery. The state of charge is equivalent to a fuel gauge and simply denotes the amount of charge that is stored in a battery. Batteries of the same rating, design, chemistry, age, and health, can have different states of charge (e.g. depending on how much they are individually charged/discharged at a given time), but they should have the same capacity and accept the same maximum state of charge and provide the same maximum nominal voltage. Conversely, the “health” (hence performance) of a battery deteriorates during its service life due to irreversible physical and chemical changes which take place with usage until eventually the battery is no longer usable. For instance, two batteries of the same rating, design, and chemistry, initially can deteriorate differently over their lives, and if one of the batteries is less “healthy” than the other, it cannot accept and store the same maximum charge than the “healthier” battery, and any attempt to treat (e.g. charge or discharge) them the same can ruin the battery bank at best and can cause disastrous consequence in the event the less “healthy” one is charged too quickly and/or overcharged.

Therefore, when batteries of different voltage and charge ratings, different designs, different chemistries, different age and health statuses with different residual runtimes and capacities, are combined in a energy storage system, and considering that the batteries will continue to age (and deteriorate at differing rates and extents) throughout its service life within the energy storage system, none of the prior art technologies encountered can meaningfully serve to manage or operate such a dynamically heterogeneous energy storage system in an effective and safe manner.

Yet further, in the event that repurposed automotive batteries are used, it would be desirable for one to be able to simply adopt and use the original controller that accompanies the battery from the factory, as opposed to having to re-invent and re-integrate a different controller for each such battery being repurposed.

### SUMMARY OF THE INVENTION

In view of the foregoing inadequacies of the prior art, an object of the present invention is to improve management and operation of energy storage systems involving multiple energy storage units of heterogeneous states of health. For the present context, the term energy storage units refers predominantly to batteries because of the state of the current technological state, and this inclusion should not be restrictively construed as technologies on energy storage devices continue to advance at a significant rate (e.g. recent advancements on super-capacitors).

According to one aspect of the present invention there is provided a method of managing a plurality of battery modules used in conjunction with at least one power supply for supplying electrical power to at least one electrical load, the method comprising:

assessing at least one state variable relating to each battery module in which said at least one state variable is indicative of a health status of the battery module; and

generating charging and discharging criteria for each battery module in which at least one of the charging and discharging criteria of each battery module is derived from the health status of the battery module such that each battery module is arranged for charging by said at least one power supply and is arranged for discharging to said at least electrical load according to the respective charging and discharging criteria associated with that battery module.

According to a second aspect of the present invention there is provided a power supply system comprising:

at least one power supply for supply electrical power to at least one electrical load;

a plurality of battery modules associated with said at least one power supply so as to be arranged to be charged by said at least one power supply and associated with said at least one electrical load so as to be arranged to supply electrical power to said at least one electrical load; and

a computer implemented control system including a computer-readable medium containing programming instructions stored thereon and at least one processor in communication with the computer readable medium so as to be arranged to execute said programming instructions so as to:
assess at least one state variable of each battery module in which said at least one state variable is indicative of a health status of the battery module; and
generate charging and discharging criteria for each battery module in which at least one of the charging and discharging criteria of each battery module is derived from the health status of the battery module such that each battery module is arranged for charging by said at least one power supply and is arranged for discharging to the at least one electrical load according to the respective charging and discharging criteria associated with that battery module.

As described herein, the state of health of a battery module is generally understood to be based upon its ability to store and deliver electrical charge. The first part pertains to battery module's capacity to hold electric charge, and the latter part pertains to the throughput of electric charge in and out of the battery module. More particularly, said at least one state variable indicative of the health status of the battery module is preferably selected from group consisting of a residual ability of the battery module to accept electric charge, a residual capacity of the battery module to hold electric charge, an internal resistance of the battery module, a conductance of the battery module, a capacitance of the battery module, a rate of charge of the battery module, a rate of discharge of the battery module under load, and a rate of self-discharge of the battery module.

According to another aspect of the present invention, there is provided a novel energy storage system, comprising:
A plurality of batteries arranged to receive power from at least one power source and to power an energy load;
At least one battery controller connected to each of the plurality of batteries for observing at least one state variable relating to each battery;
At least one charge/discharge regulator arranged between the at least one power source and each of the plurality of batteries for controlling charging and discharging of each of the plurality of batteries;
At least one processor and at least one computer-readable medium in communication with each said processor, said at least one medium containing programming instructions executable by said at least one processor to:
   observe at least one state variable associated with each of the plurality of batteries when each of the plurality of batteries is being charged;
   observe at least one state variable associated with each of the plurality of batteries when each of the plurality of batteries is being discharged;
   determine the health status of each of the plurality of batteries based on the observed values of the at least one state variable;
   generate, using a “decision method-set”, based on the determined health status of each of the plurality of batteries, respective “charging methods” for subsequent charging each of the plurality of batteries according to its respective health status; and
   control the at least one charge/discharge regulator to adjust subsequent charging of each of the plurality of batteries according to the respectively generated charging methods.

Knowing that the health (hence capacity and performance) of each of the plurality of batteries would deteriorate, and continue to deteriorate, during its service life in the energy storage system, one important objective of the novel system of the present invention is to ensure that this continual deterioration in battery health is calculated and compensated for on a going forward basis so that the operator can optimally charge each of the plurality of batteries to maximize performance whilst maintaining safety by ensuring that each of the plurality of batteries is not subject to any inappropriate charging conditions, such as over-charging.

Accordingly, it should be readily apparent to a skilled person in the art that the “charging methods” generated for re-charging each of the plurality of batteries would be quite specific to the health status of each of the plurality of batteries at a given point of its service life, and as each of the plurality of batteries continues to deteriorate throughout its service life, the respective “charging methods” for each of the plurality of batteries should be re-generated periodically (if not with every charge/discharge cycle) on a mutatis mutandis basis.

Mirroring the above, considering that the rate of deterioration of each of the plurality of batteries can be impacted by the manner that each of the plurality of batteries is discharged, the at least one computer-readable medium can also contain programming instructions executable by said at least one processor to:
generate, using a “decision method-set”, based on the determined health status of each of the plurality of batteries, respective “discharging methods” for subsequent discharging each of the plurality of batteries according to its respective health status; and
control the at least one charge/discharge regulator to adjust subsequent discharging of each of the plurality of batteries according to the respectively generated discharging methods.

Further, since the profile (e.g. rate) of deterioration of one of the plurality of batteries can differ significantly from another of the plurality of batteries over time, the accuracy of the “decision method-set”, hence the suitability of the “charging methods”, can be predictively improved by having the processor to perform the following additional steps:
generate, using a prediction method-set, based on the health statuses of each of the plurality of batteries over more than one charge/discharge cycles, and the observed values of the at least one state variable over more than one charge/discharge cycles, a subsequent “predicted health status” of each of the plurality of batteries for a subsequent charge/discharge cycle;
generate, using a “decision method-set”, based on the “predicted health status” of each of the plurality of batteries, respective “custom charging methods” and/or “custom discharging methods” to subsequently charge and discharge, respectively, each of the plurality of batteries according to the “predicted health status”.

In another embodiment of the present invention, and in addition to or in lieu of the control of the charge/discharge regulator by the at least one processor, the at least one power source is a power source with variable output, and the at least one computer-readable medium contains programming instructions executable by the at least one processor to directly adjust the power generation, hence output, of the at least variable one power source. Likewise, in cases where there are more than one power source available, the at least one computer-readable medium can also contain programming instructions for the at least one processor to directly select which (and which combination) of the more than one power sources should be engaged.

In yet another embodiment, the charge/discharge regulator disposed between each of the plurality of batteries and the load can be bi-directional and can control and adjust both the charging and discharging of each of the plurality of batteries (as opposed to having a charge regulator dedicated for adjusting charging and a separate discharge regulator dedicated for adjusting discharging. In the case where the regulator assumes both functions, the at least one computer-readable medium would contain programming instructions executable by the at least one processor to control the charge/discharge regulator to adjust charging of each of the plurality of batteries, as well as the discharging of each of the plurality of batteries (whether in supplying the load or simply isolated power dissipation).

In a further embodiment, the novel energy storage system further comprises at least one source-to-load regulator to control the power supplied by the at least one power source to the load, and the at least one computer-readable medium further contains programming instructions executable by the at least one processor to control said at least one source-to-load regulator, the power generation, hence output, of the at least one power source, the at least one charge regulator, and the at least one discharge regulator, in a coordinated manner so that the mix of power supplied by the at least one power source to the load, the power supplied by the discharge of the plurality of batteries to the load, and the power supplied by the at least one power source to charge and recharge the plurality of batteries, can be optimized situationally.

For instance, at any given time, depending on the then-current demand of the load (and then-projected demand of the load going forward), the objective a system operator may be to minimize the cost of generation/supply by the at least one power source in supplying the then-current load and then-projected load going forward by optimally mixing-in power available from the energy storage system at these times. This facet can be particularly significant, and the value provided by the energy storage system can be particularly pronounced, if any of the at least one power source is a renewable power source (especially of the intermittent type).

At the same time, the optimization can also take into account additional objectives and constraints such as maximization of the service life of the plurality of batteries (hence minimization of unit cost of power supplied by each of the plurality of batteries over its service life), and maximization of the efficiency of power supply by the at least one power source (hence minimization of unit cost of power supplied by the at least one power source).

According to another aspect of the present invention there is provided a novel computer-implemented method for managing energy storage in and supply by a plurality of batteries supplied by at least one power source and supplying an energy load co-supplied by the at least one power source, comprising:
Observing at least one state variable associated with each of the plurality of batteries (using a controller associated with each of the plurality of batteries) when each of the plurality of batteries is being charged;
Observing at least one state variable associated with each of the plurality of batteries (using a controller associated with each of the plurality of batteries) when each of the plurality of batteries is being discharged;
Determining the health status of each of the plurality of batteries based on the observed values of the at least one state variable;
generating, using a “decision method-set”, based on the determined health status of each of the plurality of batteries, respective “charging methods” for recharging each of the plurality of batteries according to its respective health status; and
adjusting the re-charging of each of the plurality of batteries according to the respectively generated charging methods.

As per the foregoing regarding the continual deterioration of each of the plurality of batteries during its service life in the energy storage system, the foregoing novel method can and should be used to ensure that this continual deterioration in battery health is calculated and compensated for on a going forward basis. As such, the foregoing method should not be viewed as a one-time exercise (e.g. done only at the initial integration of a battery to the system), but rather, should be re-iterated mutatis mutandis for subsequent discharge-recharge cycles (preferably every cycle) to continually monitor and factor in the continual deterioration of each of the plurality of batteries, and the differential rate and extent of deterioration between batteries, over the service life of the plurality of batteries in the energy storage system.

As also aforementioned, improvements to the accuracy of the “decision method-set”, hence the suitability of the “charging methods”, can be further improved by performing the following additional steps:
generating, using a prediction method-set, based on the health statuses of each of the plurality of batteries over more than one charge/discharge cycles, and the observed values of the at least one state variable over more than one charge/discharge cycles, a “predicted health status” of each of the plurality of batteries for a subsequent charge/discharge cycle; and
generating, using a “decision method-set”, based on the “predicted health status” of each of the plurality of batteries, respective “custom charging methods” to re-charge each of the plurality of batteries according to its respective “predicted health status”.

Similarly, it should be readily apparent to a skilled person in the art that application of the novel “methods” herein can include the embodiments described above for the system, and can be applied in connection with the novel energy storage “system” described above so that same objectives and benefits can be realized.

Other objects, features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from the detailed description.

### BRIEF DESCRIPTION OF THE DRAWINGS

For a more detailed disclosure of the invention and for further objects and advantages thereof, reference is to be had to the following description taken in conjunction with the accompanying drawings, in which:

FIG. 1 is a diagrammatic illustration of an example of the novel energy storage system.

FIG. 2 is a diagrammatic illustration depicting example architectures, and associated functionalities, of the controllers and regulators.

FIG. 3 is a diagrammatic illustration depicting an example architecture, and associated functionality, of the master controller.

### DETAILED DESCRIPTION OF THE INVENTION

Referring to the accompanying drawings there is illustrated the fundamental system and methods of the present invention for an improved management and operation of electricity storage systems involving multiple electricity storage units of heterogeneous states of health.

FIG. 1 is a simple diagrammatic illustration of an example of the novel energy storage system 10, which may be a 150 kWhr-rated system. In a basic example of the system, a plurality of batteries (two of which are exemplified as 20a and 20b) is provided in each module. Each module itself can comprise of multiple batteries connected in series, but it should be noted that a module can simply contain a single battery, or it can comprise multiple batteries connected in parallel as well as in series, depending on the desired capacity (e.g. voltage and current) rating of the module. For the present illustration, the rating of each module is 300-700 VDC.

The number (N) of modules included in the system would depend on the required capacity (e.g. energy) rating of the overall battery system vis-a-vis the desired purpose and requirement of the system. For example, if the purpose of the energy storage system may be to provide supplemental power to satisfy a power load that periodically exceeds the capacity of available generation, the total capacity of the energy storage system, at a most fundamental level, should be sufficient to satisfy this excess in load/demand at times of need.

Of course, in actual practice, one often would have to take into account and factor in additional objectives and constraints such as maximization of the service life of the plurality of batteries (hence minimization of unit cost of power supplied by each of the plurality of batteries over its service life), and maximization of the efficiency of power supply by the at least one power source (hence minimization of unit cost of power supplied by the at least one power source).

By way of example, for a Lithium ion battery, the capacity loss over a given number of charge/discharge cycles (i.e. deterioration in state of health) is exacerbated by higher depths of discharge (during each discharge). In other words, the more power is drawn from the battery during each discharge, the faster the deterioration of its state of health. Accordingly, in order to prolong the service life of a battery by using “shallower” depths of discharge, one would be only using a (small) fraction of the maximal amount of energy that the battery can supply. As such, a greater number of batteries would be required if the batteries are to be operated in this fashion.

By way of another example, the rate of energy transferred into the battery during charging, and the rate of energy transferred out of the battery during discharging, also significant impact the deterioration of battery health. The rates of battery charging or discharging are termed the C-rates (i.e. a 1 Ah battery discharged at 1 C rate would provide a current of 1 A for one hour, and the same battery discharged at 2 C would provide a current of 2 A for half an hour), and in general, batteries that are subject to higher C-rates would deteriorate (in health) faster. Accordingly, minimizing the rate of charge and discharge of a battery would prolong its service life, but one would only be able to rely on same battery to provide slower rates of energy supply. As such, a greater number of batteries would be required if the batteries are to be operated in this fashion.

Similarly, variables that can decelerate battery health deterioration (for lithium ion battery) include exposure of battery to lower operating temperatures, the use of lower charging voltages, and charging the battery to lower voltage levels, which all equivalently act as a reduction in the energy rating of the battery (thereby translating to the need for a greater number of batteries to achieve a given desired power supply for a given purpose).

Obviously, in actual practice, the “costs” of the compromise in effective power rating need to be weighed against the costs of the batteries, as well as other operational costs and benefits as outlined in more detail below.

Considering the diversity in the types of batteries available, batteries of different voltage and current ratings (capacities), designs, chemistries, and states of health, batteries within a given module may be “matched” and have similar voltage and current rating (capacities), design, chemistry, and state of health. That said, the voltage and current ratings (capacities), designs, chemistries, and states of health, of the batteries may differ more diversely between different modules.

In the present illustration in FIG. 1, Each battery module (e.g. 20a and 20b) is connected to and is controlled by at least one charge/discharge regulator (e.g. 40a and 40b, respectively), and in turn, each charge/discharge regulator is connected to a common DC bus 80. For the purpose of illustration, the charge/discharge regulators are rated at 3-10 kW each, and preferably they are bi-directional regulators that can be signaled and instructed to adjust power supply from the at least one power source 100 to each of the plurality of batteries (e.g. during charging) and also to adjust power supply by each of the plurality of batteries to a load 120 (e.g. during discharging). Of course, since the voltage of the power supplied to and by the plurality of batteries is in direct current (DC), an AC/DC interface (converter) 120 is used to interface the switching to alternating current (AC) (as example as illustrated, between 1000 VDC and 600 Vac). Another important function of the AC/DC interface 120 is the matching of the frequency of the power supply by the energy battery system to compensate for fluctuations in the frequency of the 600 Vac bus on the side of the load 120 and the at least one power source 100.

For better illustration, the AC/DC interface 120 in FIG. 1 is described in more detail (as 120) in FIG. 2. Similarly, the charge/discharge regulators (e.g. 40a and 40b) in FIG. 1 are also described in more detail as DC-DC controller and converter (as 40) in FIG. 2. Referring back to FIG. 1, for each of the module to be truly independent, the connections between each module to the charge/discharge regulator are protected by protected by isolation/protection devices 60a, whereas the connections between each charge/discharge regulator to the common DC bus 80 are also protected by isolation/protection devices 60b. The isolation/protection devices 60a and 60b are described in more detail (as 60a and 60b) in FIG. 2, which for the present illustration, preferably comprise of fused breakers and other switches, filters, and monitors/sensors (e.g. for detecting unsafe levels of temperature, voltage, current, and/or gaseous discharges), which serve to instantly sever any battery module from the charge/discharge regulator (e.g. in the event of a battery fault) and to instantly sever any charge/discharge regulator from the common DC bus so that any fault (or threat thereof) in a given battery module and/or its charge/discharge regulator is immediately isolated from and to preserve/protect the rest of the energy storage system. Further, another benefit of the relative independence and isolation of each of the plurality of batteries from each other is that each of the plurality of batteries can be charged and discharged independently of the others (e.g. some of the plurality of batteries can be charging while others of the plurality of batteries can be discharging) thereby offering improved flexibility for system management and utility. This feature also enables the removal of one or more of the plurality of batteries and additional of one or more additional battery to the energy storage system at any time without disturbing energy flow in the overall energy storage system.

In a preferred embodiment of the present invention (see FIGS. 1 and 2), in order to observe at least one state variable associated with each of the plurality of batteries when each of the plurality of batteries is being charged or discharged, battery controllers (e.g. 140a and 140b) are arranged with each module (e.g. 20a and 20b) of batteries for sensing and monitoring the at least one state variable. It should be readily apparent to a skilled person in the art that at times one controller may be sufficient to observe more than one state variable, but more than one separate controller may also be used in connection with each of the plurality of batteries for observing different state variables. Oftentimes, if a battery is a repurposed battery (e.g. from an electric vehicle), the battery module would already be accompanied by its controller as designed and packaged by the manufacturer. Under certain circumstances, re-using the “OEM” or “stock” controller (that comes with the battery) may be preferred option for a number of reasons, including, without limitation, convenience and avoidance of costs of re-development.

That said, there is a diverse array of battery controllers from different manufacturers, and while they may all be programmed to observe and communicate a common set of basic state variables associated with their respective batteries, these controllers can differ significantly in terms of, inter alia, their architectures, programming language and algorithms, for data management and communication. As such, in order for the energy storage system to be able to accommodate different “OEM” or “stock” controllers from different manufacturers, proper interface(s) must be put in place so that the energy storage system can properly communicate with each of the different battery controllers for e.g. data preparation and pre- and post-processing of data with respect to each of the plurality of batteries.

The sensed values (signals) of the at least one state variable by all battery controllers are, for this illustrative instance, communicated to a central communication bus (e.g. CAN Bus 160), which in turn communicates same to a master controller 200 which comprises of at least one processor and at least one computer-readable medium in communication with each the at least one processor.

The types of state variables for observation during the charging of each of the plurality of batteries can be selected, without limitation, from a group consisting of the following: battery voltage over the course of charging, charging voltage, charging current/coulomb counts (delivered to and absorbed by battery), state of charge, and internal temperature, resistance, and impedance of a battery.

Similarly, the types of state variables for observation during the discharge of each of the plurality of batteries can be selected, without limitation, from a group consisting of the following: battery voltage over the course of discharge, discharge current/coulomb counts (delivered by and extracted from the battery), type of discharge (e.g. analog vs. digital), state of discharge, rate and extent of self-discharge, and internal temperature, resistance, and impedance of a battery.

In addition, as aforementioned, other state variables ancillary to the battery or the charging/discharging processes, for example the operating temperature that each of the plurality of batteries is subject to, can also impact on the rate of deterioration of battery health and hence can be observed during charging and discharging.

From the observed values for the at least one state variables above on each of the plurality of batteries, profiles of the state variables can be plotted against charge/discharge time or against each other, and correspondingly the capacity and state of health of each of the plurality of batteries can be deduced at that particular charge/discharge cycle in its service life. With such knowledge, along with the basic knowledge of the specifications of each of the plurality of batteries (e.g. chemistry, factory rating, configuration, age), as well as the values and profiles for the at least one state variables anticipated for the next ensuing charge/discharge cycle(s) (e.g. based on projected operational requirements and environmental factors), one can develop corresponding decision method set(s) to generate optimal charging method(s) for each of the plurality of batteries so that optimal ranges and profiles of how and when different charge voltage and charge current should be delivered to each of the plurality of batteries during the ensuing charge and discharge cycle.

In practice, the computer-readable medium would contain programming instructions for execution by the at least one processor to:
observe at least one state variable associated with each of the plurality of batteries (e.g. 20), through the battery controller 140, when each of the plurality of batteries is being charged;
observe at least one state variable associated with each of the plurality of batteries (e.g. 20), through the battery controller 140, when each of the plurality of batteries is being discharged;
   and it would also contain programming instructions for execution by the at least one processor to automatically database and analyze the observed values for the at least one state variables so to determine the health status of each of the plurality of batteries (e.g. 20) based on the observed values of the at least one state variable.

Based on the determined health status of each of the plurality of batteries (e.g. 20), the computer-readable medium would also contain programming instructions for execution by the at least one processor to develop (and/or select, if and when applicable) the most appropriate “decision method-set” to generate a most appropriate “charging method” and a most appropriate “discharging method” for each of the plurality of batteries (e.g. 20) (according to its respective health status) for the ensuing charge/discharge cycle.

The actual execution of the respective “charging methods” and respective “discharging methods” is then effected via communication of control signals by the at least one processor to the at least one charge/discharge regulator 40 so that corresponding adjustments are made by each of the at least one charge/discharge regulator 40 to charge and discharge each of the plurality of batteries accordingly (for the ensuing charge/discharge cycle). This approach of using actual situational state of health of each of the plurality of batteries to determine appropriate “charging methods” and “discharging methods” are significantly more accurate and safer than the conventional approach which is simply to determine the methods based on the average impedance associated with a group or string of multiple batteries.

Once a particular charging method or discharging method is issued by the master controller 200 to the at least one charge/discharge regulator 40, it is also preferred that the appropriateness of such methods are monitored, and promptly corrected if necessary, by the system until a subsequent charging method or discharging method is issued by the master controller 200 for contingency purposes. For instance, any interim sudden fluctuation in power load 120 can impact on the voltage of the common DC bus 80, thereby requiring one or more of the plurality batteries to promptly intervene to maintain the constancy of the required operating voltage of the common DC bus 80. In an example where the voltage of the common DC bus voltage drops below the operating required voltage of the common DC bus 80 (e.g. 1000 Vdc per FIG. 1), one or more of the plurality batteries may be required to promptly discharge additionally, or switch to discharge mode even if the one or more of the plurality batteries is being charged according to the charging method(s) issued by the master controller 200. Accordingly, there is provided at least one “fine controller” (exemplified as 150 in FIG. 1 and FIG. 2) that is arranged in communication with each of the plurality of batteries or the respective at least one battery controllers 140, and with the common DC bus 80 so that such monitoring can be performed and so that each of the plurality of batteries can be situationally recruited, through acting on and adjustments made by the respective DC-DC interface(s) 40, to charge and/or discharge regardless of the then-currently applicable charging methods and discharging methods that had been issued by the master controller 200.

Another means to maintain the constancy of the required operating voltage of the common DC bus 80 is through voltage droop control. The basic underlying concept of same is to build in an intentional loss in output voltage from each of the plurality of batteries as it drives the load via the common DC bus 80, and accordingly this would increase the headroom for accommodating load transients. This intentional loss in output voltage from each of the plurality of batteries, and any required utilization of the headroom, can also be achieved through the at least one “fine controller” (exemplified as 150 in FIG. 1 and FIG. 2) acting through the respective DC-DC interface(s) 40.

Obviously, the at least one “fine controller” (exemplified as 150 in FIG. 1 and FIG. 2) should be in communication with the master controller (e.g. through the central communication bus 160, so that the master controller 200 can become aware of any and all intervention and/or droop control made (or to be made) by the at least one “fine controller” and so that the master controller 200 can factor in such intervention and control in its generation of subsequent charging method(s) and discharging method(s).

Referring to FIG. 2, and similar to the way that the observed values of the at least one state variable are communicated to the master controller 200 via the central communication bus 160, control signals by the master controller 200 to each of the at least one charge/discharge regulators to adjust charging of the respective battery module, can also be communicated via the same central communication bus 160.

In addition to these control signals destined for the at least one charge/discharge regulator 40, other signals by/from the master controller 200, such as signals for controlling the temperature that the plurality of batteries are subject to, can also be routed through the central communication bus 160.

Considering the diverse selection of signals that need to be communicated through the central communication bus 160 between the master controller 200, the plurality of heterogeneous batteries, and other ancillary sensing and control devices such as those responsible for temperature control, and all potentially at frequent time intervals, the master controller 200 must be capable of properly distinguishing and managing each and every data packet that needs to be communicated at the right times and in the right orders (so to avoid conflicts, deadlocks, etc.). One option that the master controller 200 can accomplish such functions is through a polling setup wherein the master controller 200 actively and sequentially polls each destination (e.g. one specific battery controller out of many) for data that is required by the master controller 200 at those specific given time points, and each destination would respond to the poll (request for data) accordingly. For contingency purposes, the computer-readable medium within the master controller 200 should also contain programming instructions for execution by the at least one processor to resolve any conflict or deadlock situation should they arise as a result of any dysfunction of any destination (e.g. battery controller).

Whilst the aforementioned active polling setup would work in practice, it may be preferable to have an alternative for certain situations (e.g. in large systems where a polling approach can be too cumbersome and/or slow, or where any specific battery controller is not poll-able). One such alternative is for all data packet senders to include specific “identity and destination tags” to each data package that is sent to the central communication bus 160. The destination portion of the tag would enable that the data packet would only be delivered to the rightful recipient or be recognized and used by the rightful recipient. The identity portion of the tag would identify to the rightful recipient the origin of the data packet. Of course, as data packets can oftentimes be simply continuous numerical strings, the tag should preferably encode other required information such as what state variable(s) are involved and directions for the rightful recipient to be able to interpret the numerical strings.

Of course, the above description of the use of a central master controller 200 and a central communication bus 160 represents only one example of architecture by which the plurality of batteries can be managed and operated. With the continual advancement in computer hardware and software development, more compact processors and computer-readable media with greater and greater capabilities and capacities can be directly built into each of the battery controllers 140, and even into each of the charge/discharge regulators 40, thereby rendering the use of a central master controller 200 and a central communication bus 160 unnecessary. In such a matrix or network architecture, each battery controller (e.g. 140a) would simply communicate observed values of the at least one state variable directly to the corresponding charge/discharge regulator (e.g. 40a), and in combination with observed values received directly from other ancillary sensing devices (such as those responsible for temperature control), the processor(s) and computer-readable media within the charge/discharge regulator (e.g. 40a) would execute the necessary controls and methods of the present invention. Of course, each of the plurality of charge/discharge regulators would also be in direct communication with each other to coordinate and optimize the distribution of the power supply from the at least one power sources for the energy storage system.

Having described above the operations and functions of the individual parts within the energy storage system, the multitude of factors that would impact on the state of health of each of the plurality of batteries therewithin, and the multitude of considerations that should be accounted for controlling the charge/discharge cycles for each of the plurality of batteries over its service life to ensure safety and desired performance of each of the plurality of batteries within the system, FIG. 3 is a diagrammatic illustration that ties together the foregoing.

Referring to FIG. 3, the master controller 200, upon receipt of observed values of the at least one state variable from a given battery module 20 for a given charge/discharge cycle, and through the use of the inherently programmed decision method-set, is responsible for formulating the most appropriate respective charging method and discharging method for that battery for the ensuing charge/discharge cycle. The decision in determining what may be the most appropriate, at any given time, would be a balancing act taking into account, without limitation:
the charging/discharging limits for safe operation of that battery module 20 over the subsequent charge/discharge cycle(s);
the anticipated availability of power supply by each of the at least one power source 100 over the subsequent charge/discharge cycle(s), and the (variable and fixed) costs associated with the supply of such power by each power source 100 (a power source 100 can include any option of importing power from another utility);
if the at least one power source 100 is a variable power source (e.g. diesel generator), the optimal operation range that would yield the maximum unit power produced/supplied per unit cost (e.g. range where the operating efficiency of the power source is at its maximum), and the benefits (e.g. cost savings) of maximizing operation of the variable power source within this maximum efficiency range;
the expected costs of adding additional power source(s) to increase capacity of power supply;
the anticipated availability of power supply by each of the plurality of batteries over the subsequent charge/discharge cycle(s) (especially where any non-reliable power source is involved (such as solar and wind power)), and the (variable and fixed) costs associated with the supply of such power by the energy storage system;
the costs of adding additional battery module(s) to increase capacity of power supply by the energy storage system, and also the probabilistically determined costs of any failure/severance of other battery module(s) over the ensuing charge/discharge cycle(s);
the benefits incremental (e.g. financial) of preservation/prolongation of the service life of each of the plurality of batteries 20 vs. the benefits (e.g. financial) of operating any of the plurality of batteries 20 in fashions known to accelerate battery health deterioration;
the projected energy demand by the load 120 over the ensuing charge/discharge cycle(s) and the benefits (e.g. financial) of fulfillment of all or part of such demand vis-á-vis the costs of power supply by the at least one power source 100 vs. by the energy storage system. If not fulfilling any part of the anticipated load demand is a practicable option, the costs (e.g. loss revenues, penalties) associated thereof; and
any and all interventions and/or droop control made by any of the at least one “fine controller” (exemplified as 150 in FIG. 1 and FIG. 2) over the previous and those anticipated over the subsequent charge/discharge cycle(s).

As exemplified above, the actual decision method-set should factor in a plethora of considerations according to the needs of the situation at a given time. In other words, while the values of the observed at least one state variable would be useful for defining the charging/discharging methods to ensure safety (e.g. not over-charging), which should be of paramount importance, the benefits of charging/discharging methods that simply preserve/prolong the service life of any of the plurality of batteries can be outweighed by other situational influences, especially underlying financial factors.

In practice, some of the factors and influences (i.e. the at least one state variables associated with each of the plurality of batteries) can be observed directly by the master controller 200 through its at least one battery controller 140, while others such as the specifications of each of the plurality of batteries (e.g. chemistry, factory rating, configuration, age) can be input through human machine interface 280, whether same be manual input or quasi-automated input via, for example, barcode scanning. Preferably, the master controller 200 is also arranged in communication with the utility SCADA system 300 so that it can receive the target operating point for the ac system (based on projected variables from the utility SCADA system 300). Consequently, the master controller 200 can, based on available real time rating of the at least one power source and the real time rating of the each of the plurality of batteries, can then: (i) determine and issue appropriate charge methods and discharge methods to each of the plurality of batteries appropriate for the operation of the energy system; and (ii) determine and issue appropriate control signals to the utility SCADA system 300 so that the utility SCADA system 300 can accordingly issue control instructions to adjust the power output/supply of the at least one power sources and/or to select or deselect power supply by any power sources when there are more than one power source.

Considering the multitude of variables and the relative complexity behind determination of charging methods and discharging methods, a preferred embodiment of the present invention would be to have the decision method-set performed by the at least one processor (supervisory controller 240) which can be based on mathematical optimization techniques such as convex programming (including linear, integer, and quadratic, programming), nonlinear programming (including fractional programming), and stochastic programming.

As also evident from the above is that the importance of these other situational influences oftentimes relies on projected scenarios, whether same be the projected state of health of each of the plurality of batteries, projected load demand, projected availability of power supplied by the at least one power source, etc. For example, with respect to projecting the state of health of each of the plurality of batteries, it would also be useful for the at least one computer-readable medium (Database 260) to contain programming instructions for the at least one processor to generate, using a prediction method-set, based on the health statuses of each of the plurality of batteries over more than one charge/discharge cycles, and the observed values of the at least one state variable over more than one charge/discharge cycles, a subsequent “predicted health status” of each of the plurality of batteries for a subsequent charge/discharge cycle. Correspondingly, the at least one processor, based on the programming of a “decision method-set” and the “predicted health status” of each of the plurality of batteries, would generate respective “custom charging methods” and/or “custom discharging methods” to subsequently charge and discharge, respectively, each of the plurality of batteries according to the “predicted health statuses”.

By way of example, the selection of prediction method-set may range from relatively straightforward approaches such as extrapolative or regression techniques to more sophisticated deterministic or stochastic forecasting techniques depending on the number of complexity of the variables and the situational purposes and requirements of the operator.

All publications, patents and patent applications referred to herein are incorporated by reference in their entirety to the same extent as if each individual publication, patent or patent application was specifically and individually indicated to be incorporated by reference in its entirety.

Having illustrated and described the principles of the invention in a preferred embodiment, it should be appreciated to those skilled in the art that the invention can be modified in arrangement and detail without departure from such principles. The invention is to be considered limited solely by the scope of the appended claims.

1. A method of managing a plurality of battery modules used in conjunction with at least one power supply for supplying electrical power to at least one electrical load, the method comprising:
assessing at least one state variable relating to each battery module in which said at least one state variable is indicative of a health status of the battery module;
generating charging and discharging criteria for each battery module in which at least one of the charging and discharging criteria of each battery module is derived from the health status of the battery module such that each battery module is arranged for charging by said at least one power supply and is arranged for discharging to said at least electrical load according to the respective charging and discharging criteria associated with that battery module.

2. The method according to claim 1 wherein said at least one state variable indicative of the health status of the battery module is selected from group consisting of a residual ability of the battery module to accept electric charge, a residual capacity of the battery module to hold electric charge, an internal resistance of the battery module, a conductance of the battery module, a capacitance of the battery module, a rate of charge of the battery module, a rate of discharge of the battery module under load, and a rate of self-discharge of the battery module.

3. The method according to claim 1 wherein the charging and discharging criteria are unique to each battery module.

4. The method according to claim 1 including assessing said at least one state variable of each battery module over a plurality of charging and discharging cycles of the battery module.

5. The method according to claim 1 including reassessing said at least one state variable of each battery module and regenerating the charging and discharging criteria for each battery module according to the reassessed at least one state variable at periodic intervals.

6. The method according to claim 5 wherein each periodic interval comprises one or more charging and discharging cycles of the battery module.

7. The method according to claim 1 wherein the charging and discharging criteria for each battery module includes maintaining a level of charge within prescribed limits related to the health status of the battery module.

8. The method according to claim 1 wherein the charging and discharging criteria for each battery module includes maintaining a charging or discharging rate within prescribed limits related to the health status of the battery module.

9. The method according to claim 1 including predicting a predicted health status of each battery module based on a history of assessed state variables of the battery module and generating charging and discharging criteria for each battery module in which at least one of the charging and discharging criteria of each battery module is derived from the predicted health status of the battery module.

10. The method according to claim 1 including generating the charging and discharging criteria of each battery module using a multi-variable optimization algorithm.

11. The method according to claim 1 including providing a battery controller in association with each battery module which is arranged to assess said at least one state variable in which at least one of the battery controllers is different in configuration from the other battery controllers and providing an interface which is arranged to communicate with each of the battery controllers and distinguish the battery controllers from one another.

12. The method according to claim 1 including providing a battery controller in association with each battery module which is arranged to assess said at least one state variable and providing an interface in communication between a processor and each of the battery controllers, the processor being arranged to distinguish and differentially process the assessed state variables from the different battery controllers in generating the charging and discharging criteria.

13. The method according to claim 1 including generating the charging and discharging criteria for each battery module such that discharging of one battery module is permitted while charging a different battery module.

14. The method according to claim 1 including associating an override condition with each battery module such that each battery module is arranged to be charged or discharged independently of the charging and discharging criteria if the respective override condition has been met.

15. The method according to claim 14 wherein the override condition comprises the electrical power supplied by the battery modules falling below a desired operating voltage and at least one battery module is arranged to be discharged if the override condition has been met.

16. The method according to claim 14 including providing a battery controller in association with each battery module which is arranged to assess said at least one state variable and regulate the battery module according to the charging and discharging criteria and providing an override controller associated with each battery module separate from the respective battery controller which is arranged to regulate the battery module according to the override condition.

17. The method according to claim 1 wherein each battery module comprises a single battery.

18. The method according to claim 1 wherein each battery module comprises a plurality of batteries which have related characteristics and which are commonly regulated.

19. The method according to claim 1 wherein one of the charging and discharging criteria of at least one battery module corresponds to charging said at least one battery module in response to power supplied by said at least one power supply being more than a power demand of said at least one electrical load.

20. The method according to claim 1 wherein one of the charging and discharging criteria of at least one battery module corresponds to discharging said at least one battery module in response to power supplied by said at least one power supply being less than a power demand of said at least one electrical load.

21. A power supply system comprising:
at least one power supply for supply electrical power to at least one electrical load;
a plurality of battery modules associated with said at least one power supply so as to be arranged to be charged by said at least one power supply and associated with said at least one electrical load so as to be arranged to supply electrical power to said at least one electrical load; and
a computer implemented control system including a computer-readable medium containing programming instructions stored thereon and at least one processor in communication with the computer readable medium so as to be arranged to execute said programming instructions so as to:
assess at least one state variable of each battery module in which said at least one state variable is indicative of a health status of the battery module; and
generate charging and discharging criteria for each battery module in which at least one of the charging and discharging criteria of each battery module is derived from the health status of the battery module such that each battery module is arranged for charging by said at least one power supply and is arranged for discharging to the at least one electrical load according to the respective charging and discharging criteria associated with that battery module.
